(19) United States
(12) Patent Application Publication
(10) Pub. No.: US 2021/0309868 A1
(43) Pub. Date: Oct. 7, 2021

(54) TRANSPARENT CONDUCTIVE METAL LAYERS

(71) Applicant: OrelTech Ltd., Rehovot (IL)

(72) Inventors: Natalia ZAMOSHCHIK, Rehovot (IL); Konstantin LIVANOV, Rehovot (IL)

(73) Assignee: OrelTech Ltd., Rehovot (IL)

(21) Appl. No.: 17/340,719

(22) Filed: Jun. 7, 2021

Related U.S. Application Data
(63) Continuation of application No. PCT/IB2019/060441, filed on Dec. 4, 2019.
(60) Provisional application No. 62/776,627, filed on Dec. 7, 2018.

(51) Int. Cl. C09D 5/24; B05D 3/14; C09D 1/00

(52) U.S. Cl. CPC C09D 5/24; C09D 1/00; B05D 3/145

(57) ABSTRACT

A method for growing a transparent conductive metal layer on a substrate is disclosed. The method includes the steps of applying crystal growth ink to a surface of the substrate, wherein the crystal growth ink includes a metal ionic precursor; and exposing the substrate to plasma irradiation to cause the growing of a crystalline metal framework on the substrate, wherein the exposure is based on a set of predefined exposure parameters.

### CROSS-REFERENCE TO RELATED APPLICATIONS

This application claims the benefit of an International Application No. PCT/IB2019/060441, filed on Dec. 12, 2019. The PCT/IB2019/060441 Application claims U.S. Provisional Application No. 62/776,627 filed on Dec. 7, 2018, the contents of which are hereby incorporated by reference.

### TECHNICAL FIELD

The present disclosure relates generally to properties and methods for the formation of transparent conductive metal layers (TCML) on various surfaces using plasma.

### BACKGROUND

Conductive transparent films are a necessary component in many applications, including lighting, displays, solar cells, touchscreens, and others. Currently, the field is dominated by Indium tin oxide (ITO) coatings that have high material costs, complicated application methods and limiting properties. Conventional fabrication techniques typically involve magnetron sputtering of the film, which is a very inefficient process with only a fraction of planar target material available for deposition on the substrate. Moreover, the target material used for sputtering is very expensive.

More importantly, the industrial sputter deposition process of transparent conductive oxides is a great challenge because film thickness, optical properties, and electrical properties have to be distributed uniformly over a large substrate size at the same time. Optimum resistivity and transmittance cannot be reached at the same time and often the process control is very challenging and the parameters of the power supply alone are not suitable to control this process, resulting in a very narrow process window. The very narrow process window can also be an obstacle if large area uniformity is required. It is very difficult to adjust all process parameters such as partial pressures, pumping speed, magnetic field, and oxidation state to achieve uniformity along a large target.

It would therefore be advantageous to provide a solution that would overcome the challenges noted above by providing a process of forming a transparent conducting thin film, which is inexpensive, uniform, easy to implement and results in an optimum resistivity and transmittance of the film.

### SUMMARY

A summary of several examples embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

The disclosed embodiments include a method for growing a transparent conductive metal layer on a substrate. The method includes the steps of applying crystal growth ink to a surface of the substrate, wherein the crystal growth ink includes a metal ionic precursor, and exposing the substrate to plasma irradiation to cause the growing of a crystalline metal framework on the substrate, wherein the exposure is based on a set of predefined exposure parameters.

The disclosed embodiments also include a transparent conductive metal film grown on a substrate. The film includes a framework of a plurality of crystalline flakes.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an optical microphotograph of an example of a transparent conductive metal layer, showing interconnected crystalline metal dendritic “flakes” according to an embodiment.

FIG. 2 is an optical microphotograph from FIG. 1, where stars represent crystal nodes inside the “flakes”.

FIG. 3 is an optical microphotograph from FIG. 1, where long dashed lines represent main branches inside the “flakes”.

FIG. 4 is an optical microphotograph from FIG. 1, where short dashed lines represent borders of the “flakes”.

FIG. 5 is an optical microphotograph from FIG. 1, where short dashed lines represent borders of the “flakes”. “X” signs mark connection points between the “flakes”.

FIG. 6 is an optical microphotograph of an example of a single dendritic “flake”.

FIG. 7 is an optical microphotograph from FIG. 6, where star represents a crystal node of the “flake”.

FIG. 8 is an optical microphotograph from FIG. 6, where long dashed lines represent main branches inside the “flake”.

FIG. 9 is an optical microphotograph from FIG. 6, where long dashed lines represent main branches inside the “flake”. Dotted lines represent some examples of secondary branches growing from the main branches. Secondary branches may be straight or curved and may grow in any direction.

FIG. 10 is an optical microphotograph from FIG. 6. Short dashed lines represent borders of the “flake”.

FIG. 11 is an optical microphotograph from FIG. 6. Short dashed lines represent borders of the “flake”. “X” signs mark connection points between the flake in the center and adjacent “flakes”.

FIG. 12 is an electron microscopy (SEM) image of an example of a transparent conductive metal layer.

FIG. 13 is an SEM image of an example of a dendritic crystalline “flake” secondary branch.

FIG. 14 is an SEM image of an example of a dendritic crystalline “flake” secondary branch.

FIG. 15 is a SEM image of an example embodiment of a transparent conductive metal layer showing an interconnected crystalline metal “flake” structure, where the flakes cannot be easily distinguished, and the resulting framework looks like a randomized interconnected network of metal nanocrystals.

FIG. 16 is a SEM image of an example of a transparent conductive metal layer showing an interconnected crystalline metal “flake” structure, where the flakes cannot be easily distinguished, and the resulting framework looks like a randomized interconnected network of metal nanocrystals.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and process for formation of transparent conductive metal layers (TCML) on a variety of substrates that include planar and 3-dimensional plastic, glass, and other substrates. In one embodiment, the substrates are transparent. In another embodiment, the substrates are reflective. The process, disclosed according to an embodiment, includes applying a crystal growth ink to a substrate and exposing the coated substrate to irradiation from plasma. The irradiation causes a reduction process in the crystal growth ink where metal ions within the ink receive electrons from the plasma and are converted to metal atoms, resulting in the formation of a transparent and transparent conductive metal layer on the substrate.

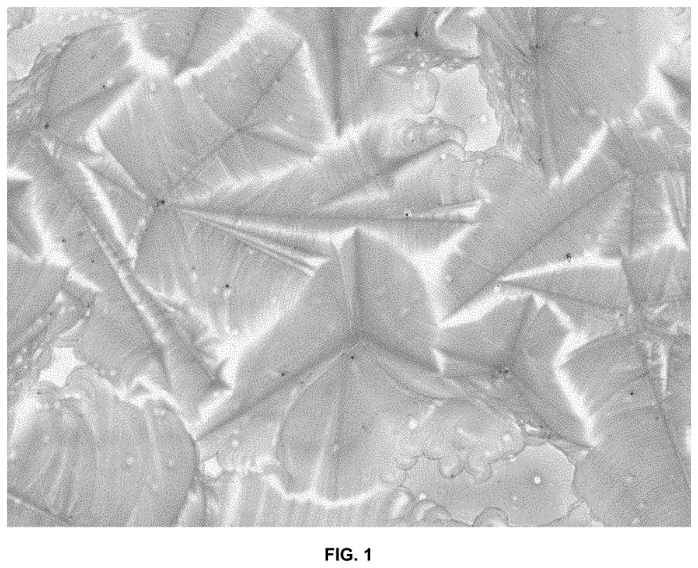

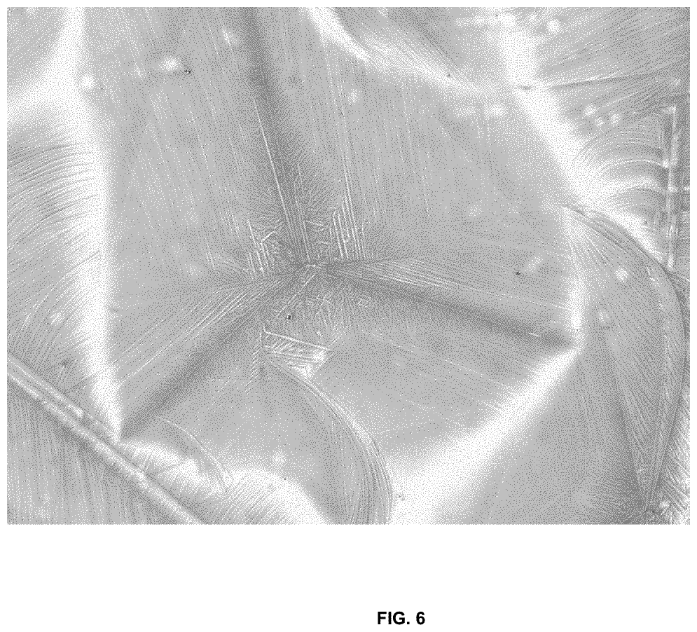

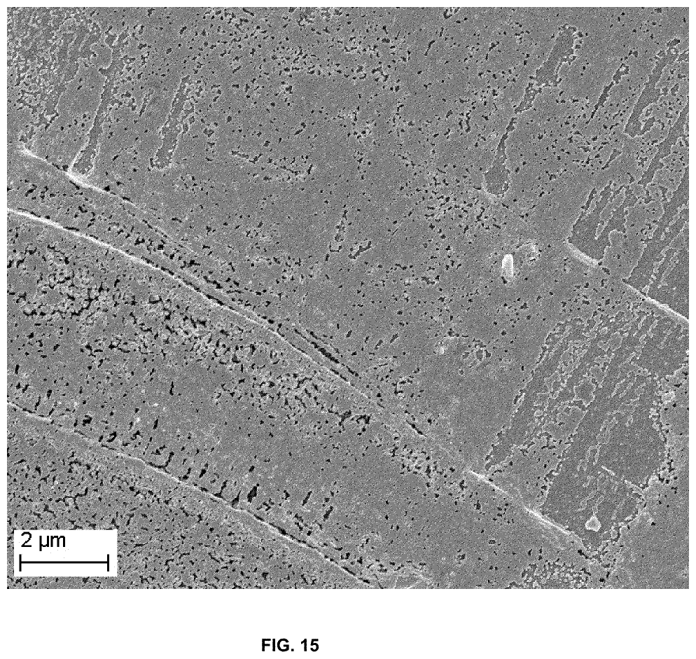

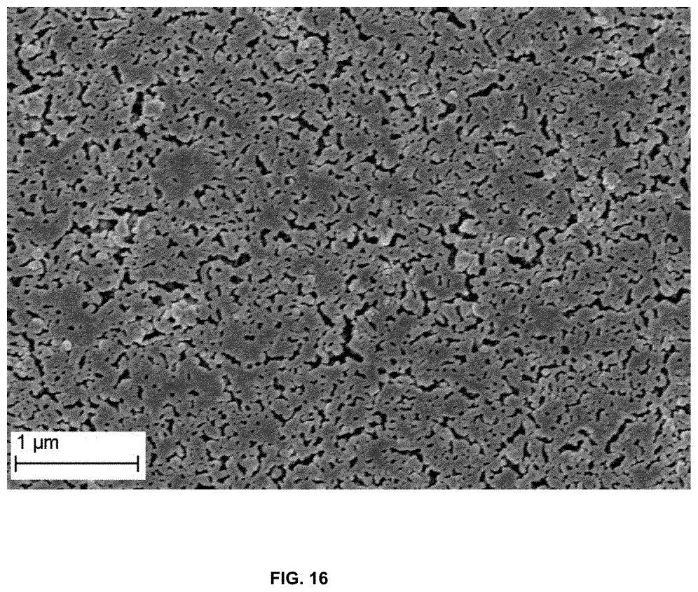

The nature of simultaneous transparency and conductivity of the resulting transparent conductive metal layer is a special arrangement of metal crystals, which form a specific sort of conductive framework. In some embodiments, this framework is simultaneously interconnected enough to provide end-to-end conductivity, and has enough voids to ensure transparency. The metal crystals grow from the crystal growth ink, which can be applied to a surface by a variety of methods. In some embodiments the metal crystals grow in a “flake”-like structure with distinctive characteristics. For example, FIG. 1 shows an optical microphotograph of an example of a transparent conductive metal layer comprised of interconnected crystalline metal dendritic “flakes” according to an embodiment of the present disclosure. FIG. 6 is an example of a single dendritic “flake.” In some embodiments the flakes cannot be easily distinguished, and the resulting framework looks like a randomized interconnected network of metal nanocrystals as shown in FIGS. 15 and 16.

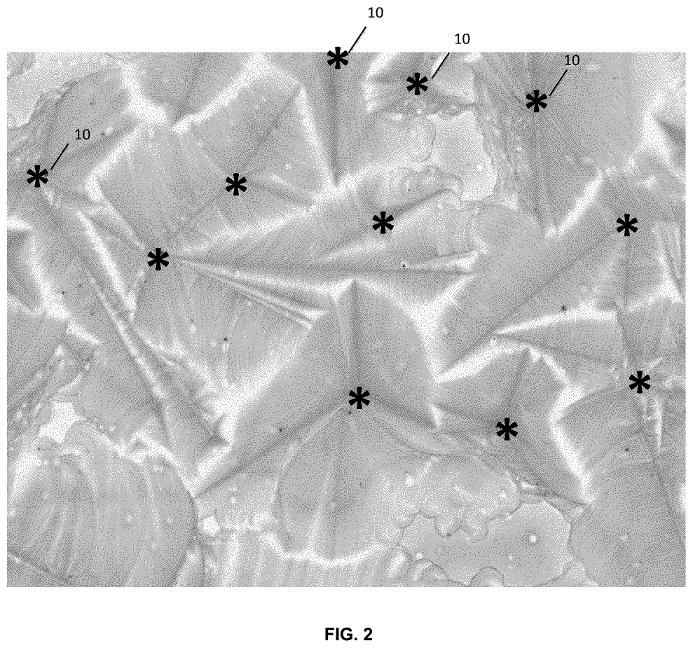

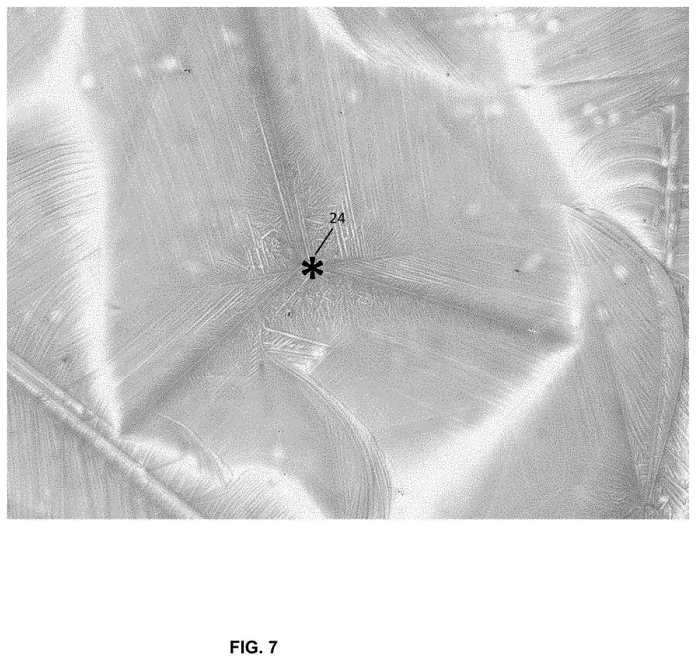

In one embodiment, the transparent conductive framework of the TCML that is formed from the crystal growth ink consists of large (10-300 μm) crystalline metal dendritic “flakes”. In the center of each “flake” there is a crystal node (FIGS. 2, 7). In some embodiments, these “flakes” have polygonal shape. These “flakes” can be tiled or adjoined edge-to-edge, or they can overlap. The “flakes” can be both convex and concave. An example of the arrangement of such “flakes” (i.e. of such conductive framework) is demonstrated on FIG. 1. An example of a single “flake” is shown on FIG. 6.

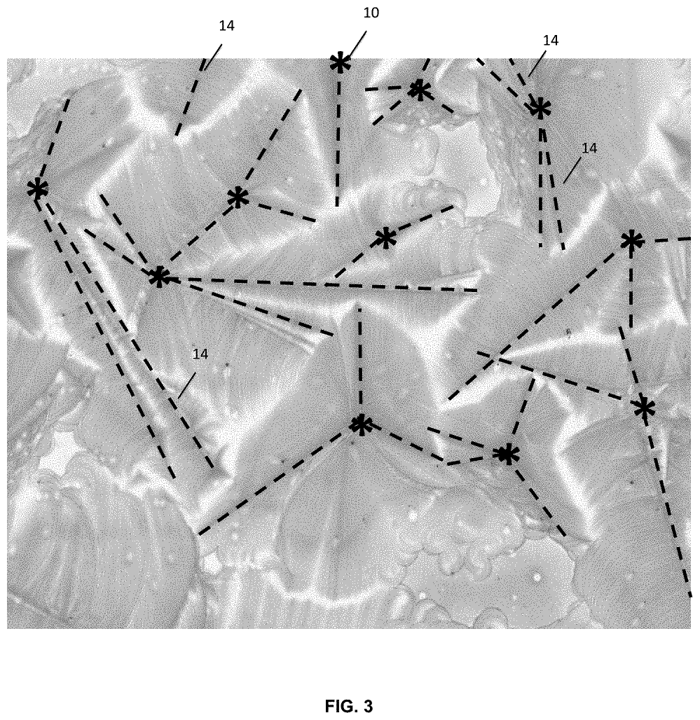

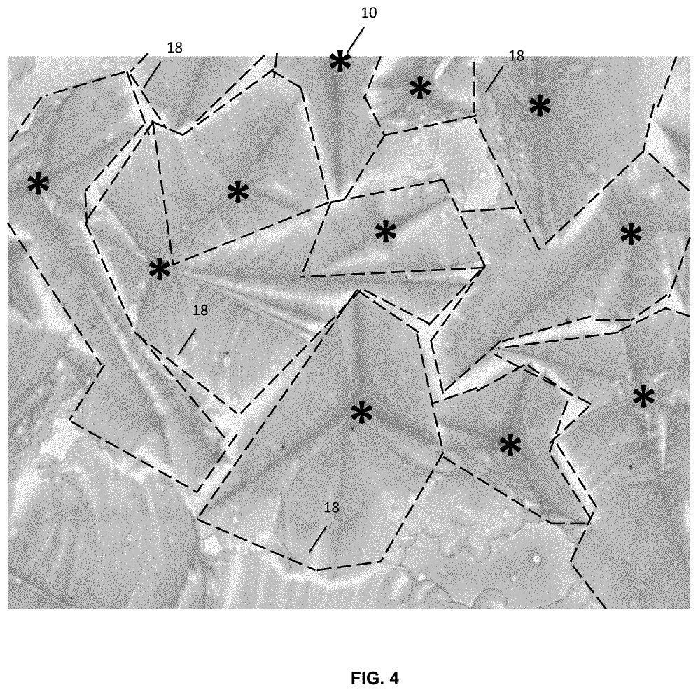

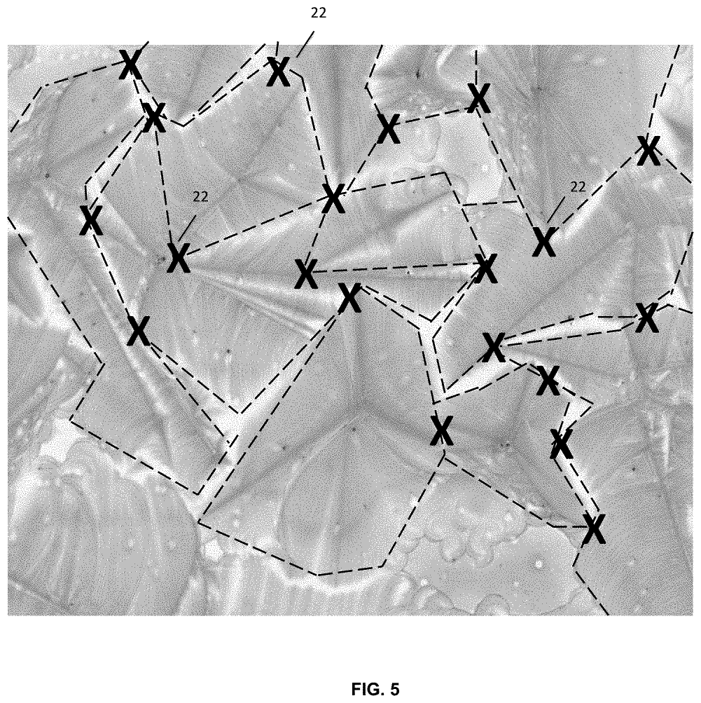

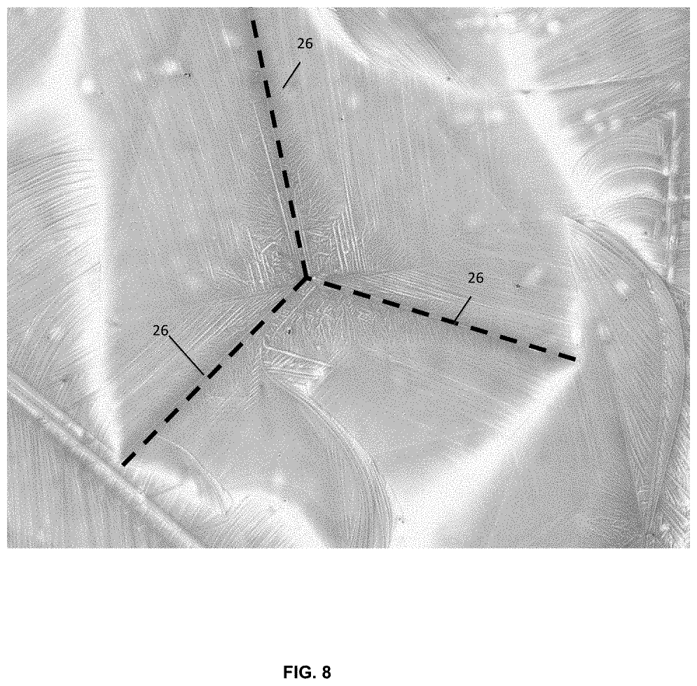

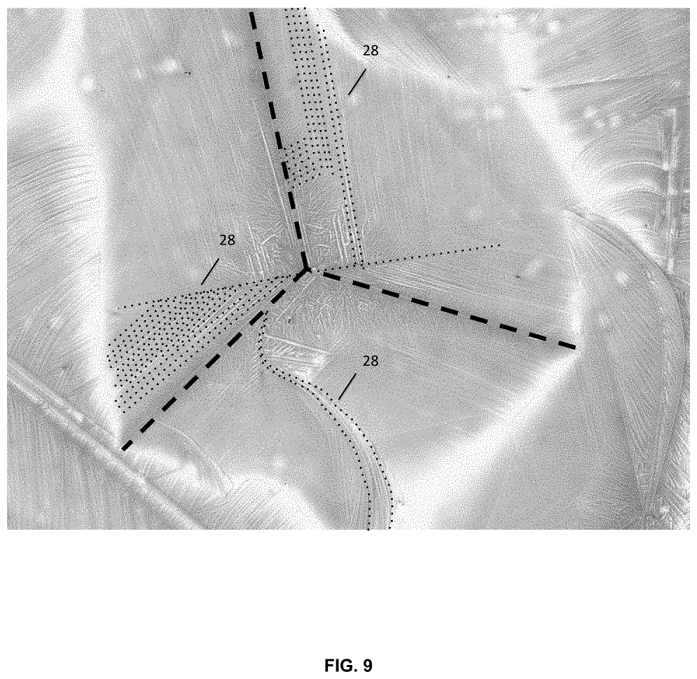

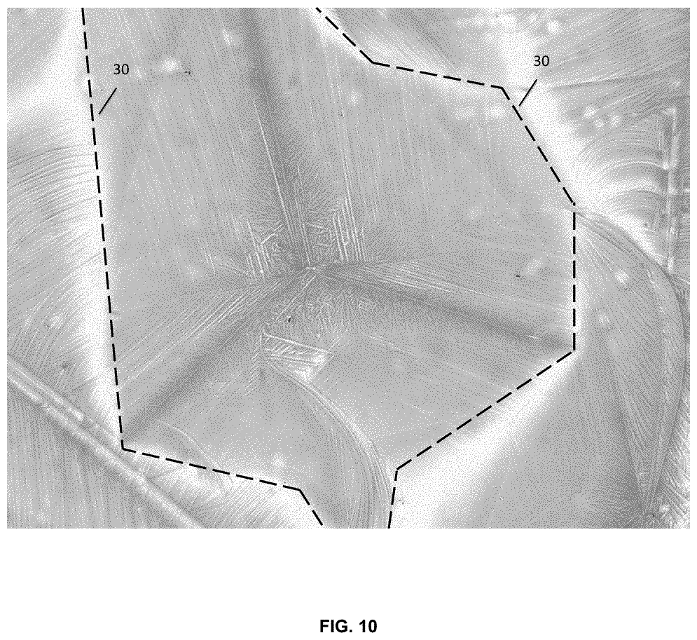

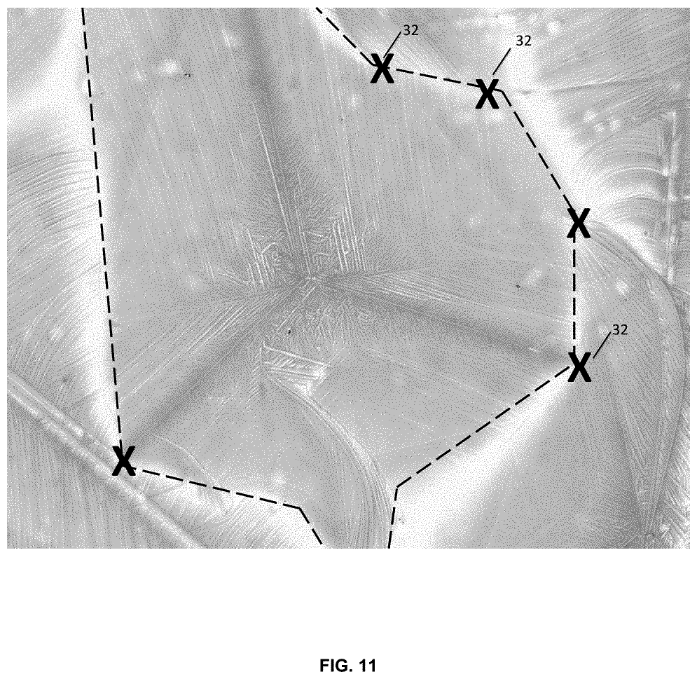

In some embodiments, the “flakes” have a dendritic, multi-branching, snowflake-like shape. In some embodiments, several thicker branches split from the center and spread over the area of the “flake” (see FIGS. 3 and 8). Herein they are called “main branches”. The main branches branch out by themselves, creating a tree-like dendritic structure. The thinner branches that start not from the nodes or other branches are called “secondary branches”. The secondary branches can be straight or curved (FIG. 9). The growth pattern, length and thickness of the main and secondary branches define the shape of the “flake”, its borders (FIGS. 4, 10) and its intersections with other flakes (FIGS. 5, 11). The connection points between the “flakes” contribute to the whole framework's conductivity. The voids between the secondary branches of the “flakes” and the void between the “flakes” themselves contribute to the whole structure's transparency.

FIGS. 2 through 5 show different elements of the conductive framework. Stars 10 shown in FIG. 2 represent crystal nodes inside the “flakes”. Dashed lines 14 shown in FIG. 3 represent main branches inside the “flakes”. Dashed lines 18 on FIG. 4 represent approximate borders of the “flakes”. “X” signs 22 on FIG. 5 marks connection points between the “flakes”.

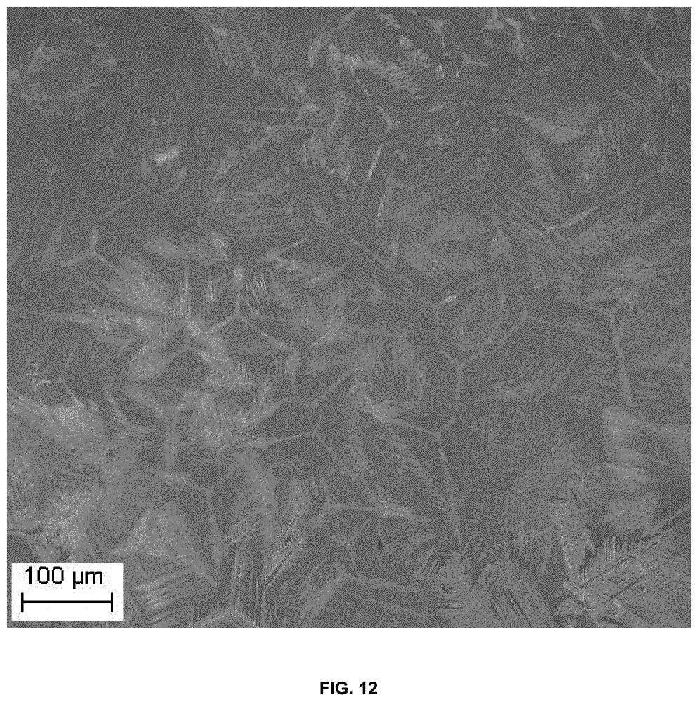

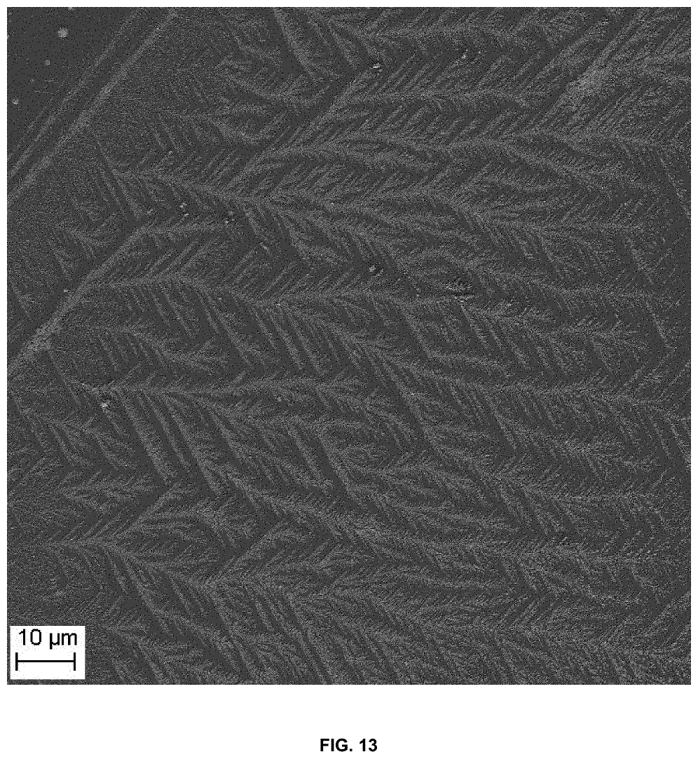

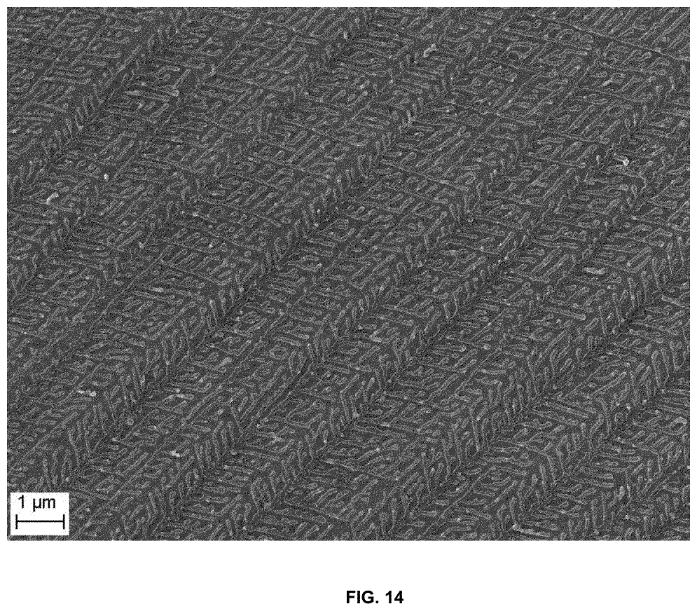

FIGS. 7 through 11 show different elements of a single “flake”. A star 24 on FIG. 7 represents crystal node inside the “flake”. Long dashed lines 26 on FIG. 8 represent main branches inside the “flakes”. Dotted lines 28 on FIG. 9 represent some of the secondary branches inside the “flake”. Short dashed lines 30 on FIG. 10 represent approximate borders of the “flake”. “X” signs 32 on FIG. 11 mark connection points between the central “flake” and the adjacent “flakes”. Several “flakes” with thicker main branches are shown on an electron micrograph picture on FIG. 12. Some examples of the tree-like dendritic nature of the main and secondary branches are shown on FIGS. 13 and 14.

In some embodiments the “flakes” cannot be identified from the SEM imaging, but the TCML retains its conductivity and transparency properties. An example of such a structure can be found in FIGS. 15 and 16. It can be clearly seen, that this is also as interconnected dendritic structure, not dissimilar to the ones shown above. In some embodiments, while the larger scale flake features (for example, “main branches”) remain, as illustrated in FIG. 15, the smaller scale features (for example, “secondary branches”) appear to be a randomized interconnected nanocrystal network, as shown in FIG. 16, for example.

In one embodiment, the crystal growth ink composition includes a metal ionic precursor, comprising between 0.01% and 20% by weight of the crystal growth ink. The composition of the crystal growth ink may be in the form of a solution, a dispersion, a suspension, a gel, or a colloid.

In some embodiments the metal ionic precursor of the crystal growth ink may be composed of a mixture of salts including one or more metal cations (i.e., positively charged ions) and counterions (i.e., ions having a charge equal to the cations, but negative). In an embodiment, the metal cations may be stabilized by either a counterion or a ligand, forming an organometallic complex, such that the resulting salt is connected by coordinate bonds rather than by ionic bonds.

In some embodiments the metal cations may be in the form of an organic or inorganic salt of at least one of the following elements: Au, Ag, Pt, Pd, Cu, Ni, Co, Zn, In, Ti, V, Mn, Fe, Cr, Zr, Nb, Mo, W, Ru, Rh, Ca, Re, Os, Ir, Al, Ga, Sn, and Sb, and their combinations. Their salts may form metallic or bimetallic nanocrystals. In some embodiments it may be preferential that the metal cations may be an organic or an inorganic salt of silver (Ag).

In some embodiments the counterions of the metal ionic precursor may be M(NO3)n, M(SO4)n, MCln, HmMCln+m, and MN, where “M” is a metal atom, or metal alloy, with a valence of “n”, H is hydrogen, NO3 is nitrate, SO4 is sulfate, Cl is chloride, “N” is alkyl-, alyl-, aceto-, carbonyl, carboxyl, cyclopentadienyl, phenyl-, biphenyl-, pyridine-, bipyridine-, aromatic, cyano-, amide and other organic moieties, and “m” is a valence of the counterion.

In some embodiments the crystal growth ink composition includes 80% to 99.99% by weight of the liquid part of the ink that includes a combination of chemical solvents whose purpose is, first, to help spreading and/or printing of the crystal growth ink on the surface, and, second, ensure the proper crystal growth parameters, including but not limited to crystal size, crystal shape, layer roughness, layer flexibility, layer transparency and layer conductivity.

In some embodiments the liquid part of the ink consists of two parts, a structuring liquid and a spreading liquid. Both of the parts can be one or a combination of several organic solvents. In some embodiments the structuring liquid has a high dynamic viscosity parameter. In some embodiments the structuring liquid has a dynamic viscosity between 20-100 centipoise (cP). In some embodiments the spreading liquid has a low surface tension parameter. In some embodiments it is preferential that the structuring liquid may include any one or combination of: cyclic alcohols, sulfoxides, formamides, ethylamines, diols, glycols, glycol ethers, glycerol, propylene carbonate, and their derivatives. In some embodiments the spreading liquid has a surface tension of 10-40 millinewtons per meter (mN/m). In some embodiments it is preferential if the spreading liquid is at least one of: alcohol, toluene, dioxane, sulfoxides, formamides, ethylamines, glycol ethers, acetonitrile, and their derivatives.

In some embodiments the liquid part of the ink only evaporates during plasma exposure under the combined effect of plasma irradiation and atmospheric pressure to medium vacuum (1×105 Pa to 1×10-1 Pa).

The disclosed method includes applying the crystal growth ink to a substrate by various means including, but not limited to, drop-casting, spray-coating, immersion, inkjet printing, aerosol spraying, slot-die casting, spin-coating, screen printing and the like. In order for the process to work, the thickness of the crystal growth ink on the substrate should not exceed 2 millimeters. The coated substrate is then exposed to irradiation from plasma. The plasma used for the irradiation includes plasma having partially ionized gas that is not in thermodynamic equilibrium, such as radio frequency (RF) plasma. Often, such plasma can exist at relatively low temperatures. Such plasma can be in both low to medium and atmospheric pressure. The use of plasma enables the conduction of a chemical reaction without exposing the surface of the substrate to high temperatures, which may damage or otherwise harm the surface or the layers below the surface of the substrate.

The plasma may include a gas such as Argon, Nitrogen, Oxygen, Hydrogen, air, Helium, Neon, Xenon, Ammonia, Ethane (C2H6), Carbon dioxide, Carbon monoxide, Methane (CH4), Propane (C3H8), Silane (SiH4), Nitrogen dioxide, Nitrogen monoxide and their combinations. In some embodiments it is preferential that the plasma gas is an inert gas. In some embodiments it is preferential that the plasma gas is Argon, Nitrogen, Neon or Xenon. To this end, the substrate is exposed to gas plasma as determined by a set of exposure parameters including, but not limited to, power, RF frequency, and time duration of the exposure. The values of the exposure parameters are determined, based in part, on the type of the substrate, the composition of the crystal growth ink, and the means of the application of the crystal growth ink.

In an embodiment, the values of the exposure parameters fall within the following ranges: the power is up to 3000 Watts (W), the plasma RF frequency is between 50 Hz and 5 GHz, and the exposure time is between 1 and 3600 seconds. In an embodiment it is preferential if the plasma power is 50-200 W, the plasma RF frequency is between 30 kHz and 20 MHz, and the exposure time is between 5 and 600 seconds. In an embodiment it is preferential that the plasma frequency is 40 kHz. In an embodiment it is preferential that the plasma frequency is 13.56 MHz.

As the substrate coated with crystal growth ink is exposed to the plasma, the metal ionic precursor therein reacts with the plasma, resulting in its electrochemical reduction. During the reduction process, the majority (at least 95%) of the liquid part of the ink evaporates, and metal ions receive electrons from the plasma and are converted into metal atoms. These processes occur simultaneously. The metal atoms assemble into a nanocrystalline framework that adheres to the substrate. The density and therefore transparency and conductivity of the framework can be controlled.

In some embodiments, the transparency of the resulting metal films is between 30% and 95% in the wavelength range of about 370 nm to 770 nm. In some embodiments the conductivity of the metal films is between 0.01 ohm/square to 500 ohm/square. In some embodiments the resulting metal films are highly flexible when grown on a flexible substrate, and do not exhibit fatal cracking after 1000 bending cycles.

Following are a few non-limiting examples for printing of transparent conductive films with different conductivity and resistivity parameters.

Example I. The crystal growth ink includes the metal ionic precursor AgNO3 with a concentration of 5 wt. % of the crystal growth ink. The ink is loaded into an Epson printhead. A PET substrate is activated using plasma irradiation for 10 seconds. The substrate is loaded into the printer and a rectangular shape is printed using the crystal growth ink. The PET is then put into a plasma chamber and the chamber is set with the following exposure parameters for power, gas flow rate, and time: RF frequency of 13.56 MHz, 150 W of power, 30 SCCM gas flow rate, and 5 minutes of exposure, respectively. The result is a conductive transparent print. The print resistivity is 4 ohm/sq. The film transparency is 50%. FIG. 2 shows an optical microscope image of similarly prepared transparent conductive film.

Example II. The crystal growth ink includes the metal ionic precursor AgNO3 with a concentration of 1 wt. % of the crystal growth ink. The ink is loaded into a Konica Minolta printhead. An A5-sized PET substrate is activated using plasma irradiation for 1 minute. The substrate is loaded into the printer and the whole substrate is printed on with the crystal growth ink. The PET is then put into a plasma chamber and the chamber is set with the following exposure parameters for power, gas flow rate, and time: RF frequency of 13.56 MHz, 150 W of power, 20 SCCM gas flow rate, and 5 minutes of exposure, respectively. The result is a conductive transparent print. The print resistivity is 130 ohm/sq. The film transparency is 70%. FIG. 4 shows an electron microscope image of similarly prepared transparent conductive film.

Example III. The crystal growth ink includes the metal ionic precursor AgNO3 with a concentration of 2.5 wt. % of the crystal growth ink. The ink is loaded into a Dimatix printhead. A glass substrate is cleaned using a piranha solution and dried thoroughly. A rectangular shape is printed with a flatbed printer using the crystal growth ink. The PET is then put into a plasma chamber and the chamber is set with the following exposure parameters for power, gas flow rate, and time: RF frequency of 13.56 MHz, 150 W of power, 30 SCCM gas flow rate, and 5 minutes of exposure, respectively. The result is a conductive transparent print on glass. The print resistivity is 15 ohm/sq. The film transparency is 80%.

Example IV. The crystal growth ink includes the metal ionic precursor AgNO3 with a concentration of 6 wt. % of the crystal growth ink. The ink is loaded into a Konica printhead. A PET substrate is activated using plasma irradiation for 20 seconds. The substrate is loaded into the printer and a rectangular shape is printed using the crystal growth ink. The PET is then put into a plasma chamber and the chamber is set with the following exposure parameters for power, gas flow rate, and time: RF frequency of 13.56 MHz, 150 W of power, 30 SCCM gas flow rate, and 2 minutes of exposure, respectively. The result is a conductive transparent print. The print resistivity is 4 ohm/sq. The film transparency is 35%.

Example V. The crystal growth ink includes the metal ionic precursor AgNO3 with a concentration of 10 wt. % of the crystal growth ink. The ink is loaded into a Spectra printhead. A PET substrate is activated using plasma irradiation for 30 seconds. The substrate is loaded into the printer and a rectangular shape is printed using the crystal growth ink. The PET is then put into a plasma chamber and the chamber is set with the following exposure parameters for power, gas flow rate, and time: RF frequency of 13.56 MHz, 150 W of power, 30 SCCM gas flow rate, and 5 minutes of exposure, respectively. The result is a conductive transparent print. The print resistivity is 30 ohm/sq. The film transparency is 60%.

Example VI. The crystal growth ink includes the metal ionic precursor AgNO3 with a concentration of 0.5 wt. % of the crystal growth ink. A PET substrate is activated using plasma irradiation for 10 seconds. The ink is spread on the PET substrate using an aerosol jet. The PET is then put into a plasma chamber and the chamber is set with the following exposure parameters for power, gas flow rate, and time: RF frequency of 13.56 MHz, 150 W of power, 30 SCCM gas flow rate, and 10 minutes of exposure, respectively. The result is a conductive transparent print. The print resistivity is 20 ohm/sq. The film transparency is 40%.

Example VII. The crystal growth ink includes the metal ionic precursor silver nitrate with a concentration of 3.5 wt. % of the crystal growth ink. The ink is loaded into a Spectra printhead. The PET substrate is loaded into the printer and a rectangular shape is printed using the crystal growth ink. The PET is then put into a plasma chamber and the chamber is set with the following exposure parameters for power, gas flow rate, and time: RF frequency of 40 kHz, 150 W of power, 30 SCCM gas flow rate, and 5 minutes of exposure, respectively. The result is a conductive transparent print. The print resistivity is 15 ohm/sq. The film transparency is 80%. FIG. 15 shows an SEM image of similarly prepared transparent conductive film.

Example VIII. The crystal growth ink includes the metal ionic precursor silver acetate with a concentration of 13 wt. % of the crystal growth ink. The ink is loaded into a Spectra printhead. An A5-sized PET substrate is activated using plasma irradiation for 1 minute. The PET substrate is loaded into the printer and a rectangular shape is printed using the crystal growth ink. The PET is then put into a plasma chamber and the chamber is set with the following exposure parameters for power, gas flow rate, and time: RF frequency of 13.56 MHz, 200 W of power, 20 SCCM gas flow rate, and 10 minutes of exposure, respectively. The result is a conductive transparent print. The print resistivity is 130 ohm/sq. The film transparency is 70%.

Example XI. The crystal growth ink includes the metal ionic precursor AuCl4H2 with a concentration of 2.5 wt. % of the crystal growth ink. The ink is loaded into a Konica acid resistant printhead. A glass substrate is cleaned using a piranha solution and dried thoroughly. A rectangular shape is printed with a flatbed printer using the crystal growth ink. The PET is then put into a plasma chamber and the chamber is set with the following exposure parameters for power, gas flow rate, and time: RF frequency of 13.56 MHz, 150 W of power, 30 SCCM gas flow rate, and 10 minutes of exposure, respectively. The result is a conductive transparent print on glass. The print resistivity is 15 ohm/sq. The film transparency is 80%.

Example X. The crystal growth ink includes the metal ionic precursor AgNO3 with a concentration of 6 wt. % of the crystal growth ink. The liquid part of the ink consists of a combination of ethylene glycol and propylene glycol as a structuring liquid, and a combination of Dowanol PM and propyl cellosolve as a spreading liquid. The ink is loaded into a Spectra printhead. The PET substrate is loaded into the printer and a rectangular shape is printed using the crystal growth ink. The PET is then put into a plasma chamber and the chamber is set with the following exposure parameters for power, gas flow rate, and time: RF frequency of 40 kHz, 200 W of power, 25 SCCM gas flow rate, and 5 minutes of exposure, respectively. The result is a conductive transparent print. The print resistivity is 70 ohm/sq. The film transparency is 85%.

Example XI. The crystal growth ink includes the metal ionic precursor silver sulphate with a concentration of 1 wt. % of the crystal growth ink. The ink is spread on a substrate using a slot-die coater. The substrate is then put into a plasma chamber and the chamber is set with the following exposure parameters for power, gas flow rate, and time: RF frequency of 13.56 MHz, 150 W of power, 30 SCCM gas flow rate, and 3 minutes of exposure, respectively. The result is a conductive transparent print. The print resistivity is 30 ohm/sq. The film transparency is 60%.

Example XII. The crystal growth ink includes the metal ionic precursor silver acetate with a concentration of 3 wt. % of the crystal growth ink. A PET substrate is activated using plasma irradiation for 10 seconds. The ink is spread on the PET substrate using a slot-die coater. The PET is then put into a plasma chamber and the chamber is set with the following exposure parameters for power, gas flow rate, and time: RF frequency of 40 kHz MHz, 150 W of power, 30 SCCM gas flow rate, and 10 minutes of exposure, respectively. The result is a conductive transparent print. The print resistivity is 20 ohm/sq. The film transparency is 40%.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for growing a transparent conductive metal layer on a substrate, comprising:
applying crystal growth ink to a surface of the substrate, wherein the crystal growth ink includes a metal ionic precursor; and
exposing the substrate to plasma irradiation to cause the growing of a crystalline metal framework on the substrate, wherein the exposure is based on a set of predefined exposure parameters.

2. The method of claim 1, wherein the crystal growth ink comprising the metal ionic precursor at a concentration between 0.01% and 20% by weight of the crystal growth ink.

3. The method of claim 1, wherein the crystal growth ink is any one of: a solution, a dispersion, a suspension, a gel, and a colloid.

4. The method of claim 1, wherein the metal ionic precursor comprising a mixture of salts including one or more metal cations and counterions.

5. The method of claim 4, wherein the metal cations are stabilized by any one of a counterion and a ligand, wherein the stabilized metal cations form an organometallic complex, such that the resulting salt is connected by coordinate bonds rather than by ionic bonds.

6. The method of claim 4, wherein the metal cations are an organic or an inorganic salt of Ag.

7. The method of claim 4, wherein the metal cations are an organic or inorganic salt of at least one of: Au, Pt, Pd, Cu, Ni, Co, Zn, In, Ti, V, Mn, Fe, Cr, Zr, Nb, Mo, W, Ru, Rh, Ca, Re, Os, Ir, Al, Ga, Sn, Sb, and combination thereof.

8. The method of claim 4, wherein the counterions of the metal ionic precursor are selected from the group consisting of: M(NO3)n, M(SO4)n, MCln, HmMCln+m, and MN, where “M” is a metal atom, or metal alloy, with a valence of “n”, H is hydrogen, NO3 is nitrate, SO4 is sulfate, Cl is chloride, “N” is alkyl-, alyl-, aceto-, carbonyl, carboxyl, cyclopentadienyl, phenyl-, biphenyl-, pyridine-, bipyridine-, aromatic, cyano-, amide and other organic moieties, and “m” is a valence of the counterion.

9. The method of claim 1, wherein the crystal growth ink comprising one or more solvents at a concentration between 80% and 99.99% by weight of the liquid part of the ink.

10. The method of claim 1, wherein the liquid part of the crystal growth ink comprising a structuring liquid component and a spreading liquid component, both of which are an organic solvent or a combination of organic solvents.

11. The method of claim 10, wherein the structuring liquid component has a high dynamic viscosity parameter.

12. The method of claim 10, wherein the structuring liquid component has a dynamic viscosity between 20 and 100 centipose (cP).

13. The method of claim 10, wherein the spreading liquid component has a low surface tension parameter.

14. The method of claim 10, wherein the structuring liquid component comprising any one or combination of: cyclic alcohols, sulfoxides, formamides, ethylamines, diols, glycols, glycol ethers, glycerol, propylene carbonate, and their derivatives.

15. The method of claim 10, wherein the spreading liquid component has a surface tension between 10 and 40 millinewtons per meter (mN/m).

16. The method of claim 10, wherein the spreading liquid component is at least one of: alcohol, toluene, dioxane, sulfoxides, formamides, ethylamines, glycol ethers, acetonitrile, and their derivatives.

17. The method of claim 1, wherein the liquid part of the ink evaporates only during exposure to plasma at a pressure ranging from atmospheric of 1—105 Pa to medium vacuum of 1×10−1 Pa.

18. The method of claim 1, wherein the applying the crystal growth ink to a surface of a substrate further comprises any one of:
drop-casting, spray-coating, immersion, inkjet printing, aerosol spraying, slot-die casting, spin-coating, and screen printing; and wherein the thickness of the crystal growth ink on the substrate is less than or equal to 2 millimeters.

19. The method of claim 1, wherein the plasma gas comprises: Argon, Nitrogen, Oxygen, Hydrogen, air, Helium, Neon, Xenon, Ammonia, Ethane (C2H6), Carbon dioxide, Carbon monoxide, Methane (CH4), Propane (C3H8), Silane (SiH4), Nitrogen dioxide, Nitrogen monoxide, and combination thereof.

20. The method of claim 1, wherein the plasma gas is an inert gas.

21. The method of claim 1, wherein the plasma gas is any one of: Argon, Nitrogen, Neon, Xenon, and combination thereof.

22. The method of claim 1, wherein the exposure parameters include: plasma power between 50 and 200 W, plasma RF frequency between 30 kHz and 20 MHz, and exposure time between 5 seconds and 600 seconds.

23. The method of claim 1, wherein the exposure parameters include a plasma frequency of 40 kHz.

24. The method of claim 1, wherein the exposure parameters include a plasma frequency of 13.56 kHz.

25. A transparent conductive metal film grown on a substrate using the method of claim 1, comprising a framework of a plurality of crystalline flakes.

26. The metal film of claim 25, wherein the transparency of the metal film is between 30% and 95% in the wavelength range of 370 nm and 770 nm.

27. The metal film of claim 25, wherein the conductivity of the metal film is between 0.01 ohm/square and 500 ohm/square.

28. The metal film of claim 25, wherein the metal film is grown on a flexible substrate and wherein the metal film is highly flexible such that it does not exhibit fatal cracking after 1000 bending cycles.

29. The metal film of claim 25, wherein the framework comprising a randomized interconnected network of metal nanocrystals.

30. The metal film of claim 25, wherein the crystalline flakes comprising large crystalline metal dendritic flakes of between 10 microns and 300 microns.

31. The metal film of claim 25, wherein each flake comprising a crystal node in its the center.

32. The metal film of claim 25, wherein the flakes are polygonal in shape.

33. The metal film of claim 25, wherein the flakes are convex or concave, or combination thereof.
